(19) United States
(12) Patent Application Publication
(10) Pub. No.: US 2006/0169303 A1
(43) Pub. Date: Aug. 3, 2006

(54) Apparatus and method for cleaning industrial vessels

(75) Inventor: Adelbert D. Burdge III, Houston, TX (US)

Correspondence Address: BROUSE MCDOWELL LPA, 388 SOUTH MAIN STREET, SUITE 500, AKRON, OH, 44311, US

(73) Assignee: Cleaning Solutions Inc.

(21) Appl. No.: 11/343,087

(22) Filed: Jan. 30, 2006

Related U.S. Application Data
(60) Provisional application No. 60/648,212, filed on Jan. 28, 2005.

(51) Int. Cl. B08B 3/10

(52) U.S. Cl. 134/18; 134/22.1; 134/22.18; 134/56 R; 134/115 R; 134/166 R; 134/169 R

(57) ABSTRACT

An apparatus includes a winding device and a windable member having a first end and a second end. The first end is operatively connected to the winding device. A rotatable nozzle device is operatively connected to the second end of the windable member. An electronic controller is in electronic communication with the winding device. The electronic controller is adapted to control a predetermined speed of the winding device. The rotatable nozzle device is adapted to provide a cleaning solution to an industrial vessel, such as a hopper or cyclone.

This application claims priority to a provisional patent application having Ser. No. 60/648,212, filed on Jan. 28, 2005.

### I. BACKGROUND OF THE INVENTION

A. Field of Invention

This invention pertains to the art of methods and apparatuses for cleaning industrial vessels. More specifically, this invention pertains to methods and apparatuses for cleaning industrial vessels that are used in the air compound milling environment, powder coating environment, but not limited thereto.

B. Description of the Related Art

It is known in the art for industrial cleaning that large industrial vessels, such as hoppers and cyclones, need routine maintenance, which includes cleaning the inside of these vessels. These vessels range in height anywhere from ten feet in height to over a hundred feet in height. Further, the inside diameters of these vessels can vary. Until now, cleaning of these vessels was performed manually. As such, cleaning of the vessels was inconsistent, as actions could vary between operators. This was mainly due to varying speed of the indexed nozzles upward as the nozzles delivered cleaning solution to the inside of the vessels. Some sections could be cleaner than others if the nozzle were lifted slower than other sections of the vessel where the nozzles could be lifted quicker.

Until now, operators climbed into these vessels with a ladder. They scraped and cleaned the inside walls of the vessels with methyl ethyl ketone, which is a flammable chemical. Despite best efforts and use of available technology, operators still could never get the equipment clean. The current cleaning process took about 124 actions, which could result in seventy-two hours of “down time.” Such long periods of down time cost money for these industries. Further, the vessels were never cleaned to acceptable levels, and when products are required to change, cross contamination commonly occurred. The present invention reduces the cleaning process to about 24 actions, which is done in 2 to 4 hours. Further, operators are not exposed to chemicals, and issues surrounding “confined spaces” are eliminated. Time is also saved from a mechanical standpoint because pipes, transfer lines and vessels do not need to be taken apart.

Another cause of inconsistent vertical speed was the drums utilized to wind hoses and chains that carried the nozzles. Initially, one speed was chosen, and this speed theoretically remained unchanged as long as the diameter of the drum did not change. However, when the hose reached its limited of winding room on the drum, it would need to continue winding. To do so, the hose would continue winding on top of itself, forming a second layer of hose. This would change the diameter of the drum, and thus change the speed of the hose.

The present invention provides methods and apparatuses for an automated cleaning system that provides consistent and more efficient cleaning of industrial vessels.

### II. SUMMARY OF THE INVENTION

The present invention is an apparatus comprising a winding device and a windable member having a first end and a second end. The first end is operatively connected to the winding device. A rotatable nozzle device is operatively connected to the second end of the windable member. An electronic controller is in electronic communication with the winding device. The electronic controller is adapted to control a predetermined speed of the winding device. The rotatable nozzle device is adapted to provide a cleaning solution to an industrial vessel, such as a hopper or cyclone.

One object of the present invention is to provide an apparatus, wherein the apparatus is portable.

Another object of the present invention is to provide an apparatus, wherein the winding device further comprises a drum and a motor operatively connected to the drum.

Further, another object of the present invention is to provide an apparatus, wherein the windable member is a cable.

Yet, another object of the present invention is to provide an apparatus, wherein the windable member is adapted to provide cleaning solution to the nozzle device.

Still yet, another object of the present invention is to provide an apparatus, further comprising a hose operatively connected to the nozzle device, the hose being adapted to deliver the cleaning solution to the nozzle device.

Another object of the present invention is to provide an apparatus, further comprising a base, an upwardly extending frame, and at least one wheel operatively connected to the base, wherein the winding device is operatively connected to the base so that the apparatus is portable.

Another object of the present invention is to provide an apparatus, further comprising a selectively removable flange adapted to be positioned on top of the industrial vessel and at least one clamp adapted to secure the flange in position, wherein the winding device is adapted to be positioned on the flange.

Another object of the present invention is to provide an apparatus wherein the industrial vessel has a top section that may be modified to allow access for the windable member and the nozzle device.

Still, another object of the present invention is to provide an apparatus, wherein the winding device comprises a spool having a first flange end, a second flange end, and a drum disposed between the first flange end and the second flange end.

Further, another object of the present invention is to provide an apparatus, wherein the drum comprises grooves adapted to receive the windable member.

Further yet, another object of the present invention is to provide an apparatus, wherein said winding device further comprises a high pressure swivel operatively connected to the first flange end and a hose operatively connected to the high pressure swivel.

It is yet another object of the present invention to provide an apparatus, wherein the spool is selectively interchangeable with different sized spools to clean different sized industrial vessels.

It is yet another object of the present invention to provide an apparatus, wherein the drum is adjustable to have different lengths.

It is yet another object of the present invention to provide an apparatus, wherein the electronic controller is variable.

Still, another object of the present invention is to provide an apparatus, wherein the nozzle device comprises a spinning member and at least one nozzle operatively connected to the spinning member.

Yet, another object of the present invention is to provide an apparatus, wherein the spinning member rotates 360 degrees.

Another object of the present invention is to provide an apparatus, wherein the electronic controller is programmed with different speeds associated with different sized industrial vessels.

Another object of the present invention is to provide a method for cleaning an industrial vessel, comprising: providing a winding device; a windable member having a first end and a second end, the first end operatively connected to the winding device; a rotatable nozzle device operatively connected to the second end of the windable member; and an electronic controller in electronic communication with the winding device; lowering the windable member a predetermined distance down the industrial vessel; choosing a speed for the windable device using the electronic controller; supplying a cleaning solution to the rotating nozzle device; raising the windable member towards a top of the industrial vessel at the predetermined speed; cleaning the industrial vessel.

Another object of the present invention is to provide a method for cleaning an industrial vessel, further comprising the step of continuously rotating the nozzle device 360 degrees.

Still, another object of the present invention is to provide a method for cleaning an industrial vessel, wherein the speed is about 2.5 inches per minute.

Still, another object of the present invention is to provide a method for cleaning an industrial vessel, wherein said winding device further comprises a spool having a first flange end, a second flange end, and a drum disposed between the first flange end and the second flange end.

Still, another object of the present invention is to provide a method for cleaning an industrial vessel, wherein the step of raising the windable member towards a top of the industrial vessel at the predetermined speed further comprises providing a motor to rotate the first flange end, winding the windable member onto the drum in a single layer in order to maintain a constant raising speed of the windable member.

Still, another object of the present invention is to provide a method for cleaning an industrial vessel, wherein the winding device is a spool that is selectively interchangeable with different sized spools for different sized industrial vessels.

Still, another object of the present invention is to provide a method for cleaning an industrial vessel, further comprising the step of changing the spool to clean a different sized industrial vessel.

Another object of the present invention is to provide an apparatus wherein the windable member has a velocity ranging from about 1/32 inch per minute to 100 feet per minute. It could also have speeds ranging from 8 feet per second to 60 feet per second.

Still, another object of the present invention is to provide a apparatus for cleaning an industrial vessel which is easy to use and cost effective for manufacturing.

Further yet, another object of the present invention is to provide an apparatus with a short operator learning curve.

Another object of the present invention is to provide an apparatus that is comprised of industry standard components to minimize manufacturing costs and enable ease of maintenance and repair.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is an elevational view of an industrial vessel system.

FIG. 2 is a front elevational view of one embodiment of the present invention.

FIG. 3 is another front elevational view of a second embodiment of the present invention.

FIG. 4 is another front elevational view of yet another embodiment of the present invention.

FIG. 5 is a perspective view of the winding device.

FIG. 6 is a front elevational view of the nozzle device.

FIG. 7 is a front elevational view of another aspect of the present invention.

### IV. DESCRIPTION OF THE PREFERRED EMBODIMENT

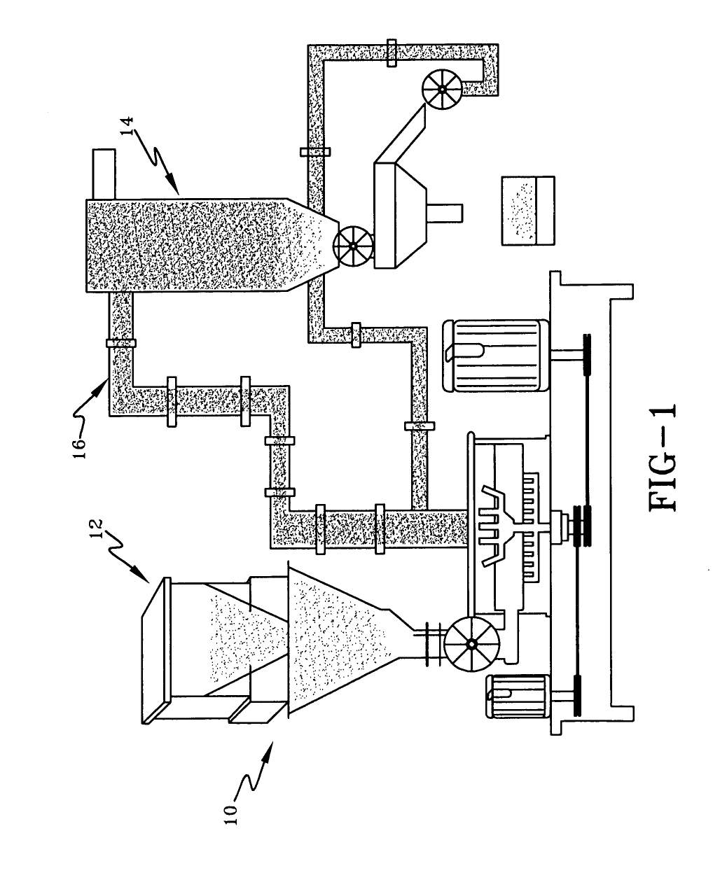

Referring now to the drawings wherein the showings are for purposes of illustrating a preferred embodiment of the invention only and not for purposes of limiting the same, FIGS. 1-7 show the present invention.

With specific reference to FIG. 1, an elevational view of an air compound milling system is shown. However, it should be understood that the present invention may be utilized in any type of industrial cleaning environment. As shown in FIG. 1, industrial vessels 10 are shown. The present invention may be utilized with any industrial vessels such as, but not limited to, a hopper 12 or a cyclone 14. It is also contemplated that the present invention may be used in transfer lines or pipes 16.

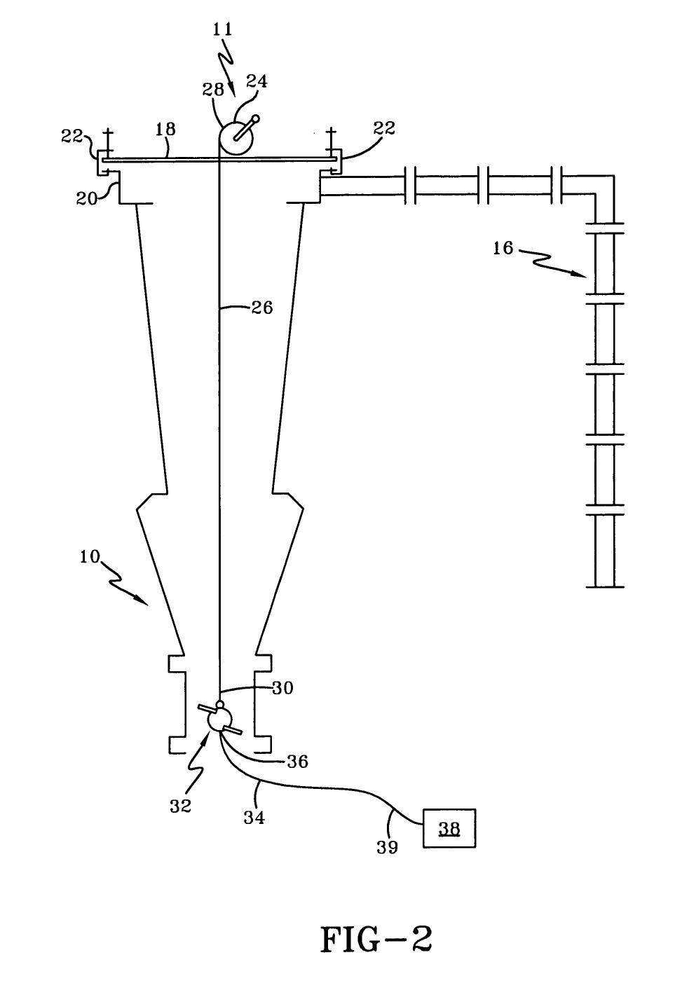

With reference to FIG. 2, one embodiment of the present invention is shown. The industrial vessel 10 is shown having a geometry including a height h and varying diameters. It also has a transfer line 16. In some instances, the transfer line may be comprised of sections of about five feet. A flange 18 may be secured to a top 20 of the industrial vessel 10 by one or more clamps 22. It is contemplated that the flange 18 may be adjustable. The flange 18 may further comprise a hole at its center, or at another predetermined location, for properly positioning the apparatus along the industrial vessel's 10 central axis. This combination provides a platform for positioning the present invention so that the industrial vessel 10 may be cleaned.

The winding device 24 may be placed on top of the flange 18. The winding device 24 will be described in fuller detail below. A windable member 26 has a first end 28 and a second end 30. The first end 28 is operatively connected to the winding device 24 by any means chosen with sound engineering judgment. The windable member 26 may be a hose, cable, chain, or other means chosen in accordance with sound engineering judgment. A rotatable nozzle device 32 is operatively connected to the second end 30 of the windable member 26. As shown in FIG. 1, the nozzle device 32 may be attached to the second end 30 of the windable member 26 by a circular ring 33. A hose 34, such as a blasting hose, is operatively connected to the nozzle device 32 at one end 36 and a pump (not shown) at a second end 38. The windable member 26 is adapted to deliver cleaning solution to the nozzle device 32. The cleaning solution may be any solution chosen in accordance with sound engineering judgment including, but not limited to, a solution composed of 100% water or partly water. It is also contemplated that the cleaning solution may be composed of only chemicals and no water. These may include, but are not limited to, water with chemical solutions, water with soluble particulate abrasives, or water with insoluble particulate abrasives. Further, air may be used in conjunction with the water. The blasting hose and apparatus may operate at pressures from about 4 psi and 50,000 psi with flow rates from 1/10 gpm to 1,000 gpm.

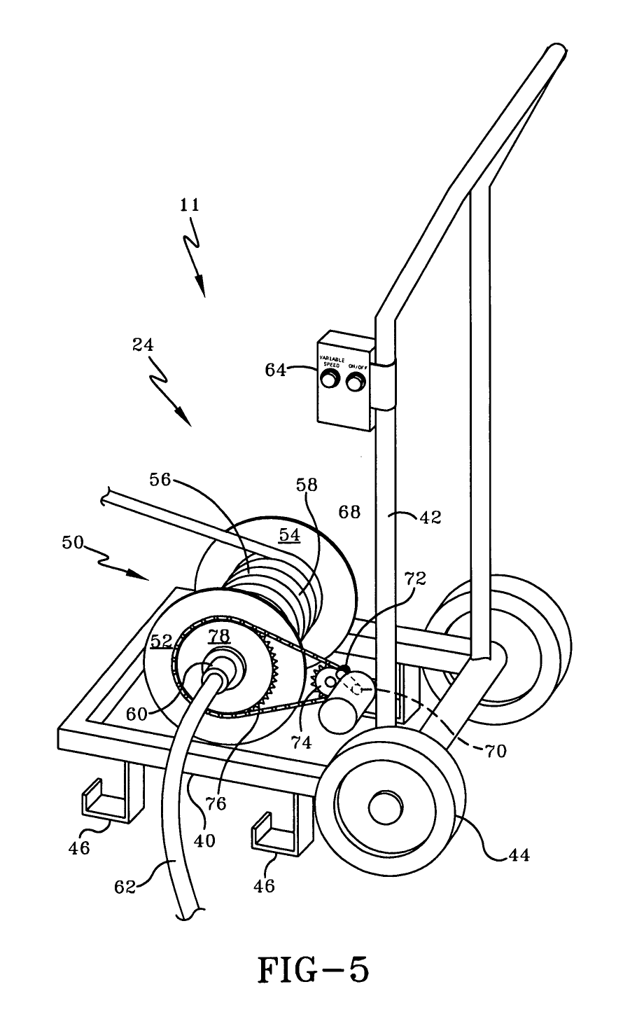

With reference to FIG. 5, the winding device 24 is shown in more detail. The winding device 24 may be attached to a dolly type device, which may comprise a base 40, an upwardly extending frame 42, and at least one wheel 44 operatively connected to the base 40. Feet 46 may be connected to the base 40. With this configuration, the winding device 24 is portable and can be easily moved between vessels 10 within a plant, and likewise, from different plants at different locations. The winding device 24 comprises a spool 50 which has a first flange end 52 and a second flange end 54. A drum 56 is disposed between the first flange end 52 and the second flange end 54. The drum 56 may also comprise grooves 58, which are adapted to receive the windable member 26. In one embodiment of the present invention, the grooves may be about one inch wide, however, the grooves may range anywhere from a quarter inch wide to three inches wide in order to accommodate different sized chains or hoses. A high pressure swivel 60 may be operatively connected to the first flange end 52. A hose 62 is then connected to the high pressure swivel, which connects to a pump. In one embodiment of the present invention, it is contemplated that the first flange end 52 and the second flange end 54 may be approximately 18 inches in diameter. It would also be contemplated that the drum 56 be approximately 12 inches in diameter. With this size spool 50, it is contemplated that a speed of 2½ inches may be cleaned per minute based upon 60 feet in about four hours. Of course, these dimensions are for one embodiment of the present invention and any other dimensions may be utilized that are chosen with sound engineering judgment.

With continuing reference to FIG. 5, an electronic controller 64 may be connected to the upwardly extending frame 42. The controller may have variable speed. A motor 66 is attached to the base 40. The motor has a transmission in order to change the rotational speed of the winding device 24, which in turn changes the linear velocity of the windable member 26. Linear velocities for the windable member may be as slow as 1/32 inch per minutes such that it is undetectable to the human eye. It is contemplated that in the linear velocity of the windable member range from about 1/32 inch per minute to about one hundred feet per minute. In another embodiment of the invention, the speed may be from 8 feet per second to 60 feet per second. In yet another embodiment, the linear velocity of the windable member range from about 1/32 inch per minute to about ten feet per minute The motor has an output shaft (not shown) which has a sprocket attached thereto. A chain then connects to another sprocket and gear 72. Another gear 74 and chain 76 are used to rotate a gear 78 which is attached to the first flange end 52 in order to rotate the winding device 24. As such, when the power on the electronic controller is turned on, the motor turns the output shaft, which in turn rotates sprocket 70 and ultimately turns gears 74, 78 through chain 76. This results in rotation of the spool 50 and the raising or lowering of windable member 26. It should be noted that any configuration of gears, sprockets, chains, pulleys or other means available to one of ordinary skill in the art may be used to transmit power from the motor 66 to the winding device 24. The configuration shown in the FIGURES is simply an example of one such configuration.

Variable speeds may be preset in relations to an industrial vessel 10 having variable diameters. Further, infinitely variable speeds are available to enable various vessel designs and conditions.

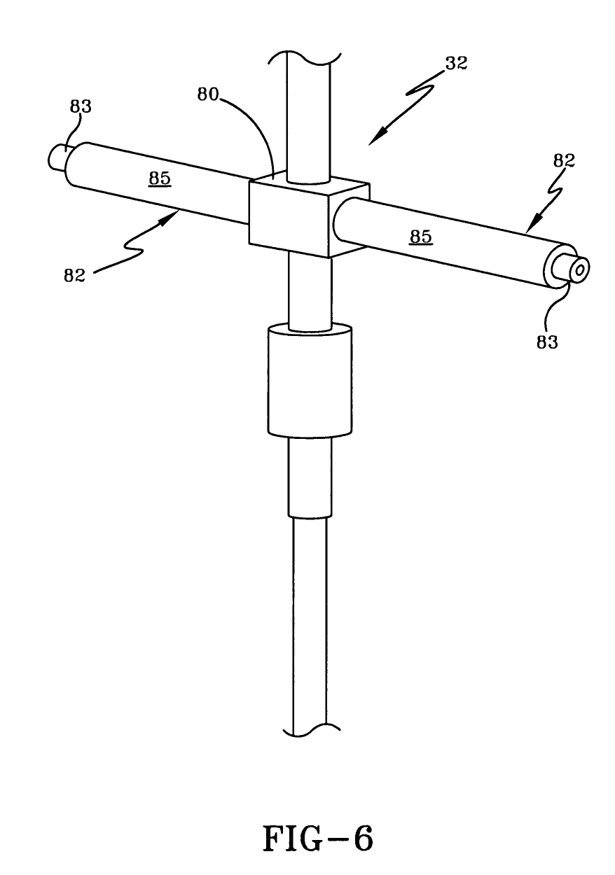

With reference to FIGS. 2 and 6, the rotatable nozzle device 32 is shown. The nozzle device 32 has a swivel or spinning member 80. The spinning member 80 is adapted to rotate 365 degrees. One or more nozzles are then operatively connected thereto. The nozzles 82 are operatively connected to the hose 34 such that a cleaning solution may be brought to the nozzle 82. The nozzle device is operatively connected to the second end 30 of the windable member 26. The rotation of the nozzle is selectable. The faster the nozzles 82 rotate, the more area of the industrial vessel 10 covers and cleans. This determines the amount of time it will take to clean the vessel 10, which then may determine what speed to set the winding device 24 with the electronic controller 64.

With continuing reference to FIGS. 2 and 6, the nozzles 82 further comprise jets 83. The jets 83 on the nozzles 82 are configured to enable a cleaning solution stream to stay in a stream longer instead of atomizing as conventional jets do. For example, a traditional nozzle may clean effectively three feet away from the nozzle body. However, the jets 83 of the present invention will have that same impact at fifteen feet away from a nozzle body 85. As previously stated, the control of speed the nozzle 83 allows consistency of movement through the vessel or pipe. This provides 100% coverage and maximizes impact on the fouling to be cleaned. For example, if the solution stream is to be at 11,000 psi at 35 gpm for 1 inch of circumference in the vessel, the present invention can be set to mimic that motion consistently as the nozzle 82 travels through the vessel, pipe or line. Human operators do not have the capability to do this consistently, and as such, operator error is eliminated through use of the present invention. The operating pressure of the nozzle device 32 may range from about 4 psi and 50,000 psi with flow rates from 1/10 gpm to 1,000 gpm.

It is also contemplated in one embodiment of the present invention that the spool 50 be selectively interchangeable. More specifically, difference spools with different sized flanges and/or drums may be used to clean different sized industrial vessels. By using different sized spools, different speeds of the winding device 24 may be used, and therefore effecting the overall time needed to clean an industrial vessel 10.

The nozzle device 32 may rotate at a speed anywhere from 1/10 to 100,000 revolutions per minute. Of course, the speed may be further adjusted if necessary in order to accommodate other applications. Then, the electronic controller 64 on the winding device 24 is set at a predetermined speed so that the windable member 26 moves up the industrial vessel 10 or transfer line 16 without spotting the interior of the vessel 10. The combination of the windable member 24 and the rotatable nozzles device 32 move at an exact speed matched to the size of the industrial vessel 10 to optimize cleaning. By doing so, the problem of consistency with cleaning is eliminated. Such nozzle devices 32 is manufactured by Stone Age Waterblasting Inc. having model numbers BJV-15K and Marten-15K. It should be noted that these nozzle devices were further modified in order to achieve the objectives of the present invention.

In order to use the present invention, the winding device 24 and windable member 26 previously described is provided. Next, the windable member 26 is lowered a predetermined distance to the bottom of the industrial vessel 10. A speed is chosen for the winding device 24 using the electronic controller 64. A cleaning solution is supplied to the rotating nozzle device 32. Further, a rotational speed for the nozzle device is chosen. Next, the windable member 24 is raised towards the top 20 of the industrial vessel 10 at the predetermined speed. As such, the industrial vessel 10 is cleaned efficiently. As previously stated, the step of raising the windable member 26 toward the top 20 of the industrial vessel 10 at the previous predetermined speed comprises the steps of winding the windable member 26 onto the drum 56 and a single layer in order to maintain a constant speed of the winding member 26. This enables consistent cleaning along the entire height of the industrial vessel 10.

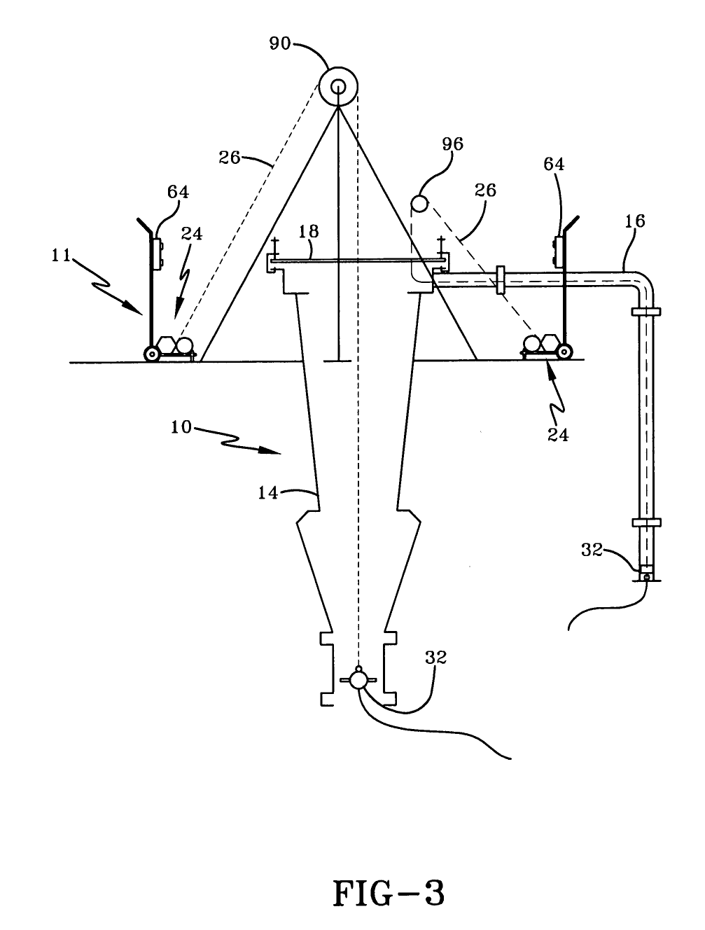

With reference to FIG. 3, another embodiment of the present invention is shown. In this embodiment, both the industrial vessel 10, which takes the form of a cyclone 14, and transfer line 16 are cleaned simultaneously. This eliminates removal of pipes, thus, saving a large portion of down time in the plant. In this embodiment, two cleaning apparatuses are utilized. A first windable member 26 trained over a pulley 90 before it is dropped to the bottom of the cyclone 14. The second cleaning device has the windable member 26 trained around a second pulley 96 at the transfer line 16. As previously described, a rotatable nozzle device 32 is chosen which then determines the speed of the winding device 24 to remove the winding member 26.

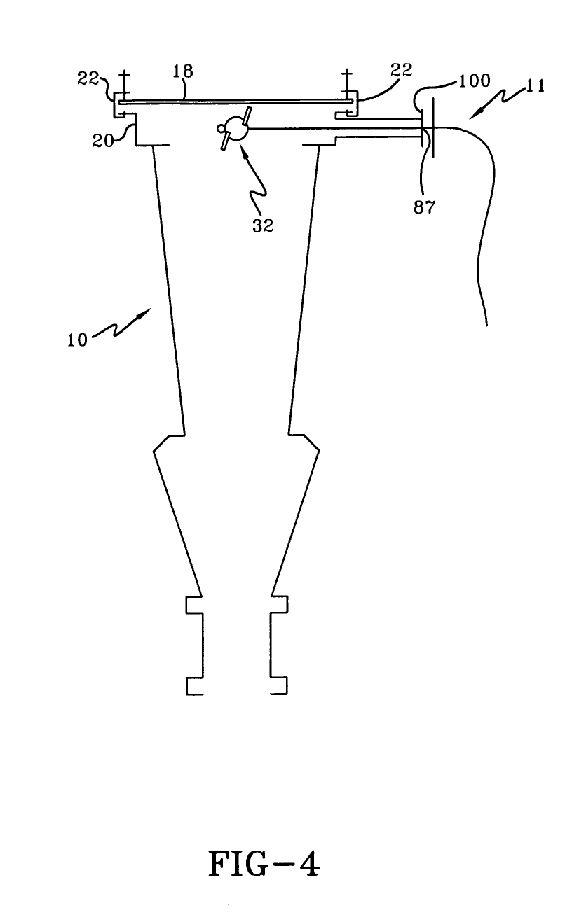

With reference to FIG. 4, another embodiment of the present invention is shown. The present invention is used to clean a pipe 100 extending horizontally from the industrial vessel 10. This embodiment shows another means for utilizing the cleaning device where it is inserted through the pipe 100. The present invention will be able to slide in and out in order to clean the pipe 100. The nozzle device 32 is equipped with the nozzle body 85 that directs the cleaning solution at an angle to the bore of the nozzle device 32. This angle is generally in the range of about 0 to about 90 degrees. This angle imparts a forward bias to the nozzle device 32, causing it to move in the opposite direction of the liquid discharge. In other embodiments of the present invention, the nozzle device 32 may not be water driven. Rather, it may be driven by hydraulics, air, mechanical, electrical or electromechanical means. The winding device 24 acts as a speed controller to limit the rotational velocity of the nozzle device 32. In this embodiment, the cleaning device 11 is attached to a centralizer 87, which may take the form of circumferentially disposed paddles, or in another embodiment spring loaded legs with wheels, but not limited thereto, to maintain its position relative to a central axis of the pipe.

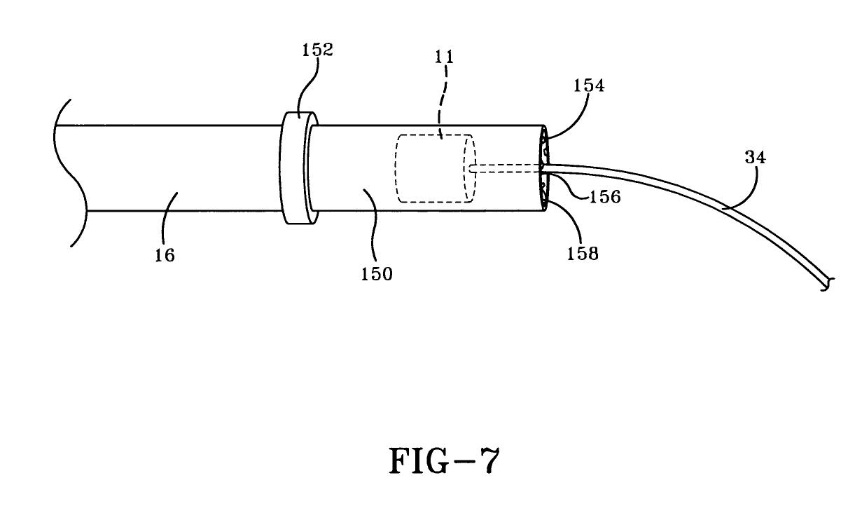

With reference to FIG. 7, another aspect of the present invention is shown. Catch boxes 150 operatively connect to the vessel 10, such as piping via a clamp 152 or other means chosen with sound engineering judgment. An end of the catch box 150 has a plug 154 with a hole 156 defined therein with rollers 158 or guides attached thereto. As such, the cleaning device 11 may be inserted into the catch box 150 so that the entire pipe is cleaned end to end. Further, the cleaning device cannot allow operators to remove it from this location without removing the catch box or deengergizing the system. Catch boxes 150 and safety devices are items we designed in the system to not only prevent operators from coming in contact with the high pressure spray but to also allow piping and vessels to be cleaned from end to end with an optional device for recycling the effluent for environmental concerns. The conventional methods of water blasting required the operator to insert the nozzle into the pipe at least a foot before pressurizing the hose. Therefore the first foot or more, the system was never energized, and as such, the vessel was never 100% cleaned. The reason operators put the nozzle in a foot before pressurizing is so the jet would not hydraulic and reverse out and injure the operator. The present invention eliminates the operator from coming into contact with the high pressure solution and achieving the acceptable cleanliness standard.

In some embodiments of the present invention, comprises high pressure rigid tubing, such as but not limited to stainless steel pipe, throughout a location or structure in order to interconnect the winding device to the pump.

The preferred embodiments have been described, hereinabove. It will be apparent to those skilled in the art that the above methods may incorporate changes and modifications without departing from the general scope of this invention. It is intended to include all such the equivalents thereof.

Having thus described the invention, it is now claimed:

1. An apparatus, comprising:
a winding device;
a windable member having a first end and a second end, said first end operatively connected to said winding device;
a rotatable nozzle device operatively connected to said second end of said windable member;
an electronic controller in electronic communication with said winding device, said electronic controller adapted to control a predetermined speed of said winding device, wherein said rotatable nozzle device is adapted to provide a cleaning solution to an associated industrial vessel.

2. The apparatus of claim 1, wherein said apparatus is portable.

3. The apparatus of claim 1, wherein said winding device further comprises:
a drum; and
a motor operatively connected to said drum.

4. The apparatus of claim 1, wherein said windable member is a cable.

5. The apparatus of claim 1, wherein said windable member is adapted to provide cleaning solution to the nozzle device.

6. The apparatus of claim 1, further comprising a hose operatively connected to said nozzle device, said hose adapted to deliver the cleaning solution to said nozzle device.

7. The apparatus of claim 2, wherein said apparatus further comprises:
a base;
an upwardly extending frame; and
at least one wheel operatively connected to said base, wherein said winding device is operatively connected to said base so that said apparatus is portable.

8. The apparatus of claim 1, further comprising:
a selectively removable flange adapted to be positioned on top of the industrial vessel; and
at least one clamp adapted to secure said flange in position, wherein said winding device is adapted to be positioned on said flange.

9. The apparatus of claim 1, wherein said winding device comprises:
a spool having a first flange end, a second flange end, and a drum disposed between said first flange end and said second flange end.

10. The apparatus of claim 9, wherein said drum comprises grooves adapted to receive said windable member.

11. The apparatus of claim 9, wherein said winding device further comprises:
a high pressure swivel operatively connected to said first flange end; and
a hose operatively connected to said high pressure swivel.

12. The apparatus of claim 9, wherein said spool is selectively interchangeable with different sized spools to clean different sized industrial vessels.

13. The apparatus of claim 9, wherein said drum is adjustable to have different lengths.

14. The apparatus of claim 1, wherein said electronic controller is variable.

15. The apparatus of claim 1, wherein said nozzle device comprises:
a spinning member; and
at least one nozzle operatively connected to said spinning member.

16. The apparatus of claim 14, wherein said spinning member rotates 360 degrees.

17. The apparatus of claim 1, wherein said electronic controller is programmed with different speeds associated with different sized industrial vessels.

18. A method for cleaning an industrial vessel, comprising:
providing a winding device; a windable member having a first end and a second end, said first end operatively connected to said winding device; a rotatable nozzle device operatively connected to said second end of said windable member; and an electronic controller in electronic communication with said winding device;
lowering said windable member a predetermined distance down the industrial vessel;
choosing a speed for the windable device using said electronic controller;
supplying a cleaning solution to said rotating nozzle device;
raising said windable member towards a top of said industrial vessel at said predetermined speed;
cleaning said industrial vessel.

19. The method of claim 18, further comprising the step of:
continuously rotating said nozzle device 360 degrees.

20. The method of claim 18, wherein said speed is about 2.5 inches per minute.

21. The method of claim 18, wherein said winding device further comprises a spool having a first flange end, a second flange end, and a drum disposed between said first flange end and said second flange end.

22. The method of claim 21, wherein the step of raising said windable member towards a top of said industrial vessel at said predetermined speed further comprises:
providing a motor to rotates said first flange end;
winding said windable member onto said drum in a single layer in order to maintain a constant raising speed of said windable member.

23. The method of claim 21, wherein said winding device is a spool that is selectively interchangeable with different sized spools for different sized industrial vessels.

24. The method of claim 23, further comprising the step of:
changing said spool to clean a different sized industrial vessel.
